(19) United States
(12) Patent Application Publication
(10) Pub. No.: US 2026/0218440 A1
(43) Pub. Date: Jul. 30, 2026

(54) FILTER CLEANING DEVICE AND CLOTHING TREATMENT

(71) Applicant: Nanjing Roborock Innovation Technology Co., Ltd., Jiangsu (CN)

(72) Inventors: Xing LI, Shenzhen, Guangdong (CN); Chuanlin DUAN, Shenzhen, Guangdong (CN); Jiansheng WU, Shenzhen, Guangdong (CN); Zhimin YANG, Shenzhen, Guangdong (CN); Xianshan HAN, Shenzhen, Guangdong (CN); Tong LIU, Shenzhen, Guangdong (CN); Hang QI, Shenzhen, Guangdong (CN); Gang QUAN, Shenzhen, Guangdong (CN)

(21) Appl. No.: 19/146,077

(22) PCT Filed: Sep. 19, 2023
(86) PCT No.: PCT/CN2023/119682

§ 371 Date: Jul. 7, 2025

(30) Foreign Application Priority Data
Jan. 5, 2023 (CN) 202320025058.6
Jan. 17, 2023 (CN) 202320180510.6
Jun. 26, 2023 (CN) 202310761575.4
Jun. 26, 2023 (CN) 202321636252.4

(51) Int. Cl. D06F 58/22; B05B 1/20; D06F 58/45

(52) U.S. Cl. CPC D06F 58/22; B05B 1/20; D06F 58/45

(57) ABSTRACT

The present disclosure relates to a filter cleaning device for cleaning a filter in a treatment apparatus configured with a filter. The filter cleaning device includes: a driving mechanism and a spraying mechanism, where the driving mechanism is configured to provide a driving force to drive the spraying mechanism to move; the spraying mechanism is connected to a water supply port of the treatment apparatus and is configured to spray a cleaning fluid onto the filter. The spraying mechanism includes a water supply assembly and a spray assembly. The water supply assembly includes a flow-guiding structure for guiding the cleaning fluid. The spray assembly is connected to the flow-guiding structure and is provided with a plurality of spray ports spaced apart from each other, which are used to spray the cleaning fluid onto the filter. The present disclosure further relates to a clothing treatment apparatus.

### CROSS-REFERENCE TO RELATED APPLICATION

The present application is a National phase of International Patent Application No. PCT/CN2023/119682 with an international filing date of Sep. 19, 2023, designating the United States, now pending, and further claims priority to Chinese Patent Application No. 202320025058.6, filed with China National Intellectual Property Administration on Jan. 5, 2023, and entitled “CLOTHING TREATMENT APPARATUS”; Chinese Patent Application No. 202320180510.6, filed with China National Intellectual Property Administration on Jan. 17, 2023, and entitled “FILTER CLEANING DEVICE AND CLOTHING TREATMENT APPARATUS”; Chinese Patent Application No. 202321636252.4, filed with China National Intellectual Property Administration on Jun. 26, 2023, and entitled “FILTER CLEANING DEVICE AND CLOTHING TREATMENT APPARATUS”; and Chinese Patent Application No. 202310761575.4, filed with China National Intellectual Property Administration on Jun. 26, 2023, and entitled “FILTER CLEANING DEVICE AND CLOTHING TREATMENT APPARATUS”; the contents each of which are incorporated herein by reference in its entirety.

### TECHNICAL FIELD

The present disclosure relates to the field of household appliance technologies, and in particular, to a filter cleaning device and a clothing treatment apparatus.

### BACKGROUND

With the continuous advancement of manufacturing technologies and the increasing demands of people's daily lives, clothing treatment apparatuses have become ubiquitous in households, emerging as one of the most commonly used household appliances. A clothing treatment apparatus is used to carry out various processes for handling clothing, such as washing, rinsing, ironing, drying, and so forth.

Under normal circumstances, a clothing treatment apparatus includes a filter, which is used to remove clothing debris, paper scraps, cotton fiber, lint, or other impurities generated within the clothing treatment apparatus. When the filter becomes clogged, users are required to remove and clean the filter before resuming the clothing treatment process. This process consumes the user's time and effort and is not sufficiently intelligent.

### SUMMARY

In view of the above situation, embodiments of the present disclosure provide a filter cleaning device and a clothing treatment apparatus. The filter cleaning device is configured to spray onto the filter to remove clothing debris, paper scraps, cotton fiber, lint, or other impurities generated within the clothing treatment apparatus.

The embodiments of the present disclosure provide a filter cleaning device, which is configured to clean a treatment apparatus configured with a filter. The filter cleaning device includes: a driving mechanism and a spraying mechanism.

The driving mechanism is configured to provide a driving force to drive the spraying mechanism to move.

The spraying mechanism is connected to a water supply port of the treatment apparatus and is configured to spray a cleaning fluid onto the filter; the spraying mechanism includes a water supply assembly and a spray assembly.

The water supply assembly is connected to the water supply port, and the water supply assembly includes a flow-guiding structure configured to guide the cleaning fluid; the spray assembly is connected to the flow-guiding structure, and the spray assembly is provided with a plurality of spray ports spaced apart from each other.

In one embodiment, the flow-guiding structure is a water supply connecting member; the water supply assembly further includes: a water supply pipe. The water supply connecting member is connected to the water supply port, and the water supply pipe is connected to the water supply connecting member.

The spray assembly includes: a spray head. The plurality of spray ports spaced apart from each other are spray holes, and the spray holes are arranged on the same surface of the spray head.

The water supply pipe and the spray holes are respectively arranged on two surfaces of the spray head facing away from each other.

In one embodiment, the spray holes are spaced apart from each other along the first direction; the movement distance of the spraying mechanism in the first direction is greater than or equal to the minimum distance between two adjacent spray holes.

In one embodiment, the rotation angle of the spraying mechanism ranges from 5° to 45°.

In one embodiment, the spraying mechanism further includes a switch configured to open or close one or more of the spray holes.

In one embodiment, the water supply assembly further includes a water inlet port and a water inlet device, and the water inlet port is connected to the water supply port.

The spray assembly includes a spray pipe, and the spray pipe is connected to the water inlet device; the spray pipe is provided with a plurality of spray ports spaced apart from each other and is configured to spray the cleaning fluid from the spray ports.

The flow-guiding structure is a water distributor, and the water distributor is connected to the water inlet device and is configured to guide the cleaning fluid to the spray pipe.

In one embodiment, the water distributor includes: a first water dividing plate. The first water dividing plate is provided with a first through hole, and the cleaning fluid flows out from the first through hole.

In one embodiment, the water distributor further includes: a second water dividing plate. The second water dividing plate moves relative to the first water dividing plate; the second water dividing plate is provided with at least a first water dividing hole and a second water dividing hole, and the cleaning fluid in the first through hole flows to the spray pipe via the first water dividing hole or the second water dividing hole.

In one embodiment, when the second water dividing plate moves relative to the first water dividing plate, there are at least a first position and a second position. The first position is a position where the first water dividing hole and the first through hole have an overlapping projection area in the first direction; the second position is a position where the second water dividing hole and the first through hole have an overlapping projection area in the first direction. The first direction is the direction in which the length of the spray pipe extends.

In one embodiment, the spray pipe is provided with a hollow structure, and a partition member is arranged inside the spray pipe; the partition member is configured to divide the spray pipe into a first spray sub-pipe and a second spray sub-pipe.

In one embodiment, the first water dividing hole is located upstream of the first spray sub-pipe, and the sectional area of the first water dividing hole is less than or equal to the sectional area of the first spray sub-pipe; the second water dividing hole is located upstream of the second spray sub-pipe, and the sectional area of the second water dividing hole is less than or equal to the sectional area of the second spray sub-pipe.

In one embodiment, in the first direction, the pipe wall of the first spray sub-pipe and the pipe wall of the second spray sub-pipe are each provided with the spray ports spaced apart from each other. The line connecting the spray ports to the central axis of the rotary spray pipe is perpendicular to the extension plane of the partition member.

In one embodiment, in the first direction, the pipe wall of the first spray sub-pipe and the pipe wall of the second spray sub-pipe are each provided with the spray ports spaced apart from each other. The spray ports of the first spray sub-pipe and the spray ports of the second spray sub-pipe are arranged in a staggered manner in the first direction.

In one embodiment, the spray pipe includes at least a first section of the spray pipe and a second section of the spray pipe; both the first section of the spray pipe and the second section of the spray pipe are provided with beveled surfaces; the beveled surface of the first section of the spray pipe is connected to the beveled surface of the second section of the spray pipe, and the beveled surface of the first section of the spray pipe and the beveled surface of the second section of the spray pipe are adapted to the position of the spray port.

In one embodiment, along the thickness direction of the pipe wall of the spray pipe, the spray port includes a first hole segment and a second hole segment. The second hole segment is arranged on one side of the first hole segment away from the rotation axis of the spray pipe, and the diameter of the first hole segment is less than the diameter of the second hole segment.

In one embodiment, the thickness of the spray pipe is denoted as TH1, and the thickness of the first hole segment is denoted as TH2, where TH1>TH2>⅝TH1.

In one embodiment, the driving mechanism includes a drive motor, which is configured to drive the spray pipe to rotate around the rotation axis of the spray pipe, with a rotation angle of 60° to 360°.

In one embodiment, the driving mechanism includes a telescopic drive motor, which is configured to drive the spray pipe to move up and down along the length extension direction of the spray pipe.

In one embodiment, the surface of the spray assembly facing the filter is a flat surface or a curved surface.

In one embodiment, the distance between the spraying mechanism and the filter is within the range of 0.4 cm to 1 cm.

In one embodiment, the spraying mechanism sprays the cleaning fluid onto the filter, with the spray area being greater than or equal to 80% of the filtration area of the filter.

In one embodiment, the filter is provided with a limiting member, which is configured to limit the movement of the spraying mechanism within a preset range.

In one embodiment, a clothing accommodating device, a drying device, a filter, and the filter cleaning device according to any one of the above embodiments are included.

The drying device includes a moisture adsorption unit and a moisture desorption unit. The moisture adsorption unit is configured to adsorb moisture in an airflow led out from the clothing accommodating device, and the moisture desorption unit is configured to desorb the moisture adsorbed by the moisture adsorption unit.

The filter is arranged between an air outlet of the clothing accommodating device and an air inlet of the drying device to filter the airflow.

The filter cleaning device is arranged on a non-filtering surface of the filter and is configured to clean the filter.

In one embodiment, the drying device includes: a moisture adsorption-desorption rotary disk.

The moisture adsorption-desorption rotary disk is rotatable.

The housing is configured to accommodate the moisture adsorption-desorption rotary disk; the internal space of the housing is divided into at least a moisture adsorption space and a moisture desorption space.

The moisture adsorption-desorption rotary disk, when rotating into the moisture adsorption space, serves as a moisture adsorption unit.

The moisture adsorption-desorption rotary disk, when rotating into the moisture desorption space, serves as a moisture desorption unit.

In one embodiment, the drying device further includes: an air outlet duct.

The air outlet duct is configured to guide the airflow from the clothing accommodating device to the drying device; the filter is arranged within the air outlet duct.

In one embodiment, the clothing accommodating device includes an inner drum and an outer drum.

An air outlet of the clothing accommodating device is arranged on the rear wall of the outer drum.

The length of the air outlet duct is greater than more than half of the diameter of the outer drum.

The details of one or more embodiments of the present disclosure are set forth in the drawings and the description below. Other features, objectives, and advantages of the present disclosure become apparent from the specification, the drawings, and the claims.

### BRIEF DESCRIPTION OF THE DRAWINGS

To more clearly illustrate the technical solutions in the embodiments of the present disclosure, the drawings required for use in the embodiments will be briefly described below. It should be understood that the following drawings only illustrate some embodiments of the present disclosure and therefore should not be considered as limiting the scope of the present disclosure, and other related drawings can be derived from these drawings by those of ordinary skill in the art without creative efforts. In the drawings:

FIG. 1 illustrates a schematic structural diagram of a clothing treatment apparatus according to an embodiment of the present disclosure;

FIG. 2 illustrates a schematic structural diagram of a clothing treatment apparatus according to another embodiment of the present disclosure;

FIG. 3 illustrates a schematic structural diagram of an inner drum according to an embodiment of the present disclosure;

FIG. 4 illustrates a schematic structural diagram of an outer drum according to an embodiment of the present disclosure;

FIG. 5 illustrates a schematic structural diagram of an outer drum according to another embodiment of the present disclosure;

FIG. 6 illustrates a schematic structural diagram of an outer drum according to another embodiment of the present disclosure;

FIG. 7 is a schematic diagram of the partially enlarged structure at section I in FIG. 6;

FIG. 8 illustrates a schematic diagram of a mounting position of a filter according to an embodiment of the present disclosure;

FIG. 9 illustrates a schematic structural diagram of a filter cleaning device according to an embodiment of the present disclosure;

FIG. 10 illustrates a physical view of a filter cleaning device according to an embodiment of the present disclosure;

FIG. 11 illustrates a schematic diagram of a mounting position of a filter cleaning device outside a clothing accommodating device according to an embodiment of the present disclosure;

FIG. 12 illustrates a schematic diagram of a partial structure of a filter cleaning device according to an embodiment of the present disclosure;

FIG. 13 illustrates a schematic diagram of a partial structure of a filter cleaning device according to an embodiment of the present disclosure;

FIG. 14 illustrates a schematic structural diagram of an air outlet duct of a clothing treatment apparatus according to an embodiment of the present disclosure;

FIG. 15 illustrates a schematic diagram of an overall structure of a filter cleaning device according to an embodiment of the present disclosure;

FIG. 16 illustrates a schematic diagram of a partial structure of a spray assembly in a filter cleaning device according to an embodiment of the present disclosure;

FIG. 17 illustrates a schematic diagram of another partial structure of a spray assembly in a filter cleaning device according to an embodiment of the present disclosure;

FIG. 18 illustrates a schematic structural diagram of a spray pipe in a filter cleaning device according to an embodiment of the present disclosure; and

FIG. 19 illustrates a schematic diagram of a detailed structure of a spray pipe in a filter cleaning device according to an embodiment of the present disclosure.

### DESCRIPTION OF THE REFERENCE NUMERALS

frame 100; inner drum 200; outer drum 300; air outlet 310; cleaning member 12; driving structure 13;
clothing accommodating device 1100, drying device 2000, air outlet duct 1300, first end part 1301, second end part 1302;
filter 601, limiting member 602;
filter cleaning device 6200: driving mechanism 6210: drive motor 6101, gearbox 6102, motor sealing ring 6108, driving connection member 6109; spraying mechanism 6220: water supply assembly 6230, spray assembly 6240; spray head 6103, spray hole 6104, water supply pipe 6105, first blocking block 6106, water supply connecting member 6107 (water supply hose); water supply port 6231, water inlet device 6232; spray port 6241, first hole segment 6241-1, second hole segment 6241-2; spray pipe 6242, partition member 6242-1, first spray sub-pipe 6242-2, second spray sub-pipe 6242-3, first section of the spray pipe 6242-4, second section of the spray pipe 6242-5, connecting part 6242-6; water distributor 6243: first water dividing plate 6243-1, first through hole 6243-11, second water dividing plate (movable plate) 6243-2, first water dividing hole 6243-21, second water dividing hole 6243-22; connecting shaft 6244, first sealing ring 6245-1, second sealing ring 6245-2.

### DETAILED DESCRIPTION

The technical solutions in the embodiments of the present disclosure will be clearly and completely described hereinafter with reference to the drawings in the embodiments of the present disclosure. It is apparent that the described embodiments are only some, but not all, embodiments of the present disclosure. The assemblies of the embodiments of the present disclosure generally described and illustrated in the drawings herein may be arranged and designed in various configurations. Therefore, the following detailed description of the embodiments of the present disclosure provided in the drawings is not intended to limit the scope of the present disclosure as claimed, but merely represents selected embodiments of the present disclosure. Based on the embodiments of the present disclosure, all other embodiments obtained by those skilled in the art without creative efforts (including new embodiments formed by combining features included in different embodiments) shall fall within the protection scope of the present disclosure.

It should be noted that similar reference numerals and letters refer to similar items in the following drawings, and thus, once an item is defined in one of the drawings, it does not need to be further defined or explained in the subsequent drawings. Meanwhile, in the description of the present disclosure, the terms “first”, “second”, and the like are used for distinguishing descriptions only and should not be construed as indicating or implying relative importance.

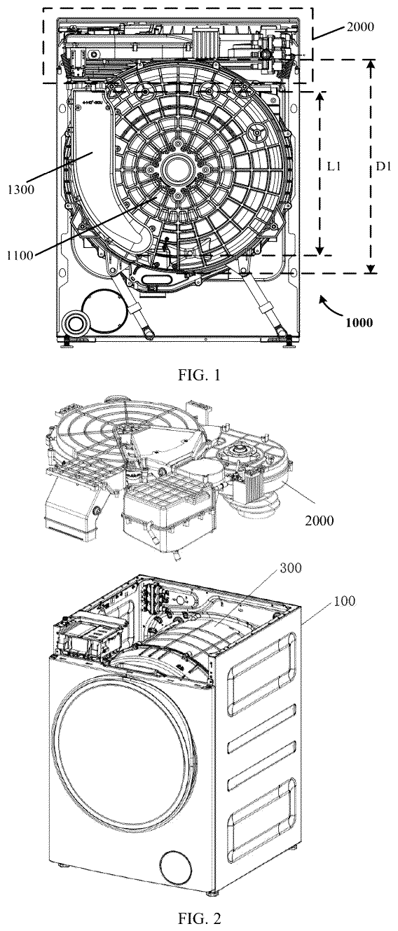

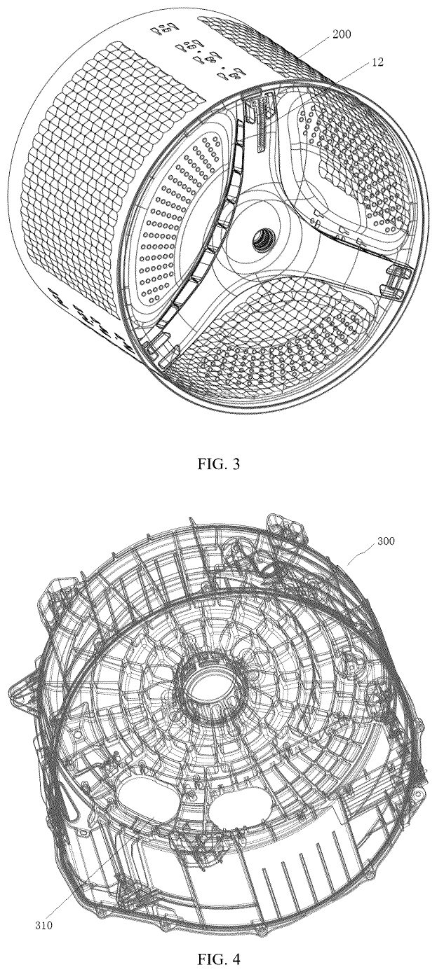

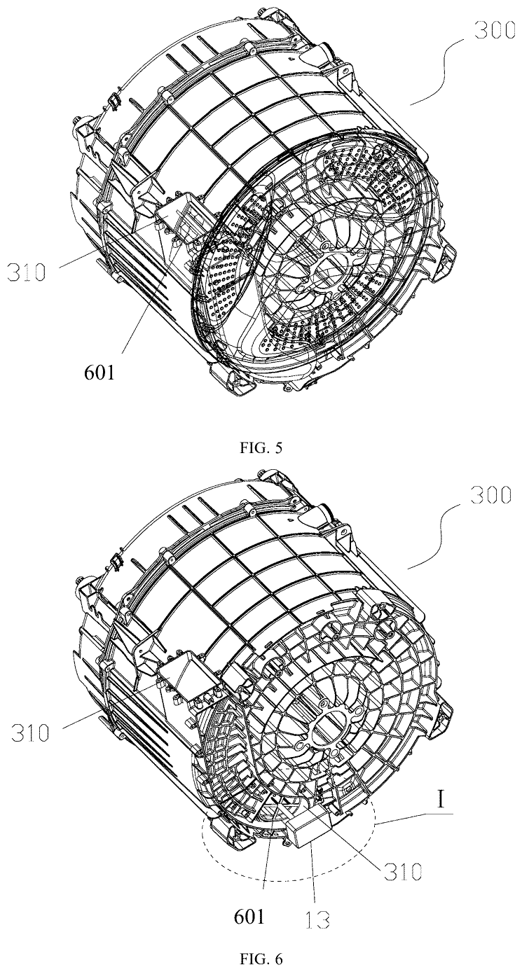

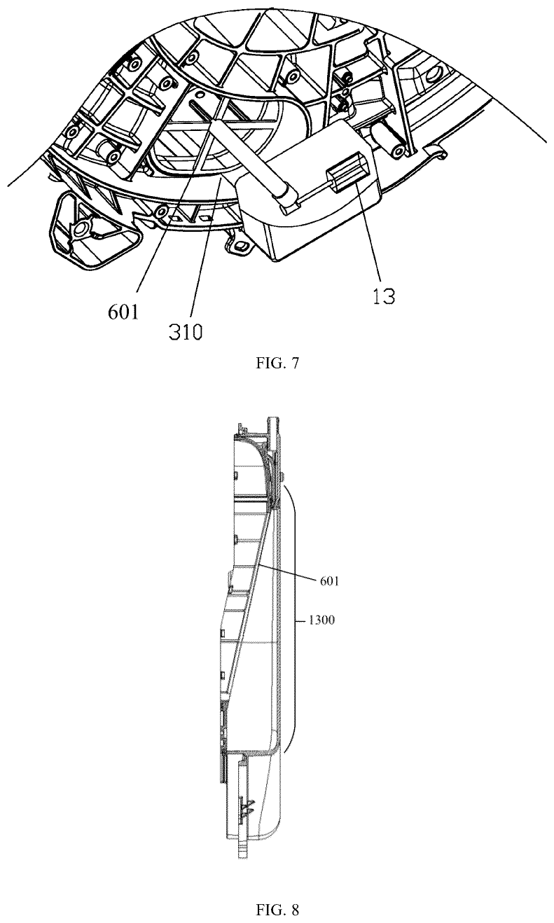

The embodiments of the present disclosure provide a clothing treatment apparatus. As shown in FIGS. 1 to 7, the clothing treatment apparatus includes: a frame 100, a drum, a drying device 2000, and the like. The drum may be arranged in the frame 100, and the drum may include an inner drum 200 and an outer drum 300. In order to minimize the overall size of the clothing treatment apparatus, the drying device 2000 may be mounted at the top of the drum, and the drying device 2000 is arranged in a horizontal manner. The outer drum 300 may be arranged on the frame 100 in a fixed or vibrating manner, and the inner drum 200 may be rotatably arranged in the outer drum 300. The driving shaft of the inner drum 200 may be provided at the center of the bottom wall of the inner drum 200. The drum air inlet is located at the front part or the rear part of the frame 100, and the drum air outlet is located at the rear part or the front part of the frame 100. The drum air inlet and the drum air outlet are each in communication with the space between the outer drum 300 and the inner drum 200 of the drum. The humid airflow in the drum can be converted into dry airflow after the moisture is desorbed via the drying device 2000 through the drum air outlet. The dry airflow then enters the drum through the drum air inlet and comes into full contact with the clothing, thereby improving the drying efficiency. This process is repeated in this manner. In one embodiment of the present disclosure, the outer drum is provided with an air outlet, and a filter screen member is provided close to the air outlet. The filter screen member is used to trap the lint in the airflow passing through the air outlet. For example, the bottom wall of the outer drum 300 may be provided with an air outlet 310, and the air outlet 310 is provided with a filter 601; the filter 601 is used to trap the lint in the airflow passing through the air outlet 310. The airflow passing through the air outlet 310 may be the humid airflow in the drum that flows toward the drying device 2000 via the air outlet 310; the inner drum 200 is rotatably arranged in the outer drum 300. In some embodiments, at least one cleaning member is provided on one side of the inner drum opposite to the filter screen member. The cleaning member rotates along with the inner drum and thus is in intermittent contact with the filter screen member to remove the lint attached to the filter screen member. Specifically, at least one cleaning member 12 is provided on the bottom wall of the inner drum 200; the cleaning member 12 protrudes from the bottom wall of the inner drum 200, and the cleaning member 12 is in intermittent contact with the filter 601 through the rotation of the inner drum 200, thereby removing the lint attached to the filter 601. In another embodiment of the present disclosure, the air outlet 310 may be provided on the side wall of the outer drum 300, and the filter 601 is provided at the air outlet 310. Correspondingly, at least one cleaning member 12 is provided on the side wall of the inner drum 200. In this way, the cleaning member 12 is in intermittent contact with the filter 601 through the rotation of the inner drum 200, thereby cleaning the lint attached to the filter 601. In the embodiments of the present disclosure, the cleaning member 12 may preferably be provided as a bristle strip or a scraper, and the scraper may be made of a flexible material. The inner drum 200 and the outer drum 300 may be arranged to be substantially parallel to each other, and a certain gap is correspondingly provided between the bottom walls and the side walls of the inner drum 200 and the outer drum 300. The cleaning member 12 may slightly protrude from the bottom wall or the side wall of the inner drum 200, and the cleaning member 12 may be provided close to the outer periphery of the bottom wall of the inner drum 200. During rotation, the cleaning member 12 cleans the filter 601 once each time the cleaning member rotates to the air outlet 310. During the continuous circumferential rotation of the inner drum 200, the cleaning member intermittently sweeps across the surface of the filter 601, thereby removing the lint adhered to the filter 601. In this way, the lint in the humid airflow flowing to the drying device 2000 via the air outlet 310 is filtered and trapped by the filter 601, thus preventing a large amount of lint from accumulating on the drying device 2000. Since the cleaning member 12 can remove the lint adhered to the filter 601, the flow rate of the humid airflow will not decrease due to the clogging of the filter 601 by the lint in the humid airflow, thereby improving the drying efficiency and the drying effect on the clothing, while also protecting the drying device 2000 and prolonging the service life thereof.

In some embodiments, the cleaning member may be arranged on the bottom wall or the side wall of the inner drum. Correspondingly, the filter screen member is arranged near the air outlet on the bottom wall or the side wall of the outer drum. In an exemplary embodiment, the cleaning member 12 includes a bristle strip or a scraper. The bristle strip may be provided with a plurality of bristles in a fixed manner, and the scraper may be made of a flexible material, so as to facilitate the removal of the lint adhered to the filter 601. The cleaning member 12 may further include a mounting base plate, on which the bristle strip or the scraper is connected fixedly. The mounting base plate is detachably fixed to the bottom wall or the side wall of the inner drum 200 by means of bolt connection or the like. Correspondingly, the air outlet is provided on the bottom wall or the side wall of the outer drum. The filter 601 may include a filter screen and a framework. The filter screen is wrapped on one side of the framework, and the other side of the framework is fixedly connected to the bottom wall or the side wall of the outer drum, allowing the filter screen to cover the air outlet, thereby effectively trapping the lint in the airflow passing through the air outlet 310. Since the filter screen is located close to the bottom wall or the side wall of the inner drum 200, the cleaning member 12, during rotation, cleans the filter 601 once each time the cleaning member rotates to the air outlet 310. During the continuous circumferential rotation of the inner drum 200, the cleaning member intermittently sweeps across the surface of the filter 601, thereby removing the lint adhered to the filter 601.

Further, in order to improve the cleaning efficiency, in one embodiment, the following design is included.

The filter member and/or the cleaning member 12 are capable of reciprocating in a direction close to or away from each other.

In some embodiments, the cleaning member 12 is configured to move away from or close to the bottom wall of the inner drum 200, and the direction of movement is parallel to the axis along which the inner drum 200 rotates, such that the filter 601 can be selectively in contact with the cleaning member 12. When the clothing treatment apparatus starts a washing or rinsing process, the extraction of humid airflow from the drum to the drying device 2000 is not required. Therefore, the cleaning member 12 moves toward the direction close to the bottom wall of the inner drum 200, thereby creating a gap between the cleaning member 12 and the surface of the filter 601. In this way, during the continuous circumferential rotation of the inner drum 200, the cleaning member 12 is not in contact with the surface of the filter 601, and the cleaning of the filter 601 is not required. When the clothing treatment apparatus starts the spinning or drying process, the humid airflow in the drum is extracted and directed to the drying device 2000. As a result, the lint in the humid airflow flowing to the drying device 2000 via the air outlet 310 is filtered and trapped by the filter 601. Therefore, the cleaning member 12 moves toward the direction away from the bottom wall of the inner drum 200, such that the cleaning member 12 is in contact with the surface of the filter 601. In this way, during the continuous circumferential rotation of the inner drum 200, the cleaning member 12 intermittently sweeps across the surface of the filter 601, thereby removing the lint adhered to the filter 601.

In some embodiments, the filter 601 is configured to move away from or close to the bottom wall of the inner drum 200, and the direction of movement is parallel to the axis along which the inner drum 200 rotates, such that the filter 601 can be selectively in contact with the cleaning member 12. When the clothing treatment apparatus starts a washing or rinsing process, the extraction of humid airflow from the drum to the drying device 2000 is not required. Therefore, the filter 601 moves toward the direction away from the bottom wall of the inner drum 200, thereby creating a gap between the cleaning member 12 and the surface of the filter 601. In this way, during the continuous circumferential rotation of the inner drum 200, the cleaning member 12 is not in contact with the surface of the filter 601, and the cleaning of the filter 601 is not required. When the clothing treatment apparatus starts the spinning or drying process, the humid airflow in the drum is extracted and directed to the drying device 2000. As a result, the lint in the humid airflow flowing to the drying device 2000 via the air outlet 310 is filtered and trapped by the filter 601. Therefore, the cleaning member 12 moves toward the direction close to the bottom wall of the inner drum 200, such that the cleaning member 12 is in contact with the surface of the filter 601. In this way, during the continuous circumferential rotation of the inner drum 200, the cleaning member 12 intermittently sweeps across the surface of the filter 601, thereby removing the lint adhered to the filter 601.

In some embodiments, an air outlet duct 1300 is provided at the air outlet 310 of the outer drum 300. The air outlet duct 1300 is located on one side of the outer drum 300 facing away from the inner drum 200, and the air outlet duct 1300 is in communication with the drying device 2000, such that the humid airflow filtered by the filter 601 flows to the drying device 2000.

In some embodiments, the filter 601 includes a filter screen and a holder. The filter screen is mounted on the holder, the air outlet of the outer drum is formed as a cylindrical hole, and the holder is slidably arranged in the cylindrical hole. The filter screen may be fixedly connected to one end of the holder; the holder is matched with the air outlet 310, and the holder may slide along the hole wall of the cylindrical hole to realize the reciprocating movement of the filter 601 close to or away from the inner drum. The depth of the cylindrical hole needs to accommodate the movement range of the filter 601. The holder can provide excellent support for the filter screen, the air outlet 310 is provided on the bottom wall of the outer drum 300, and the cross section shape of the air outlet 310 may be provided as a rectangular hole, a circular hole, a kidney-shaped hole, or the like, which is not limited herein. In the embodiments of the present disclosure, the cross section shape of the air outlet 310 is preferably a kidney-shaped hole, which can prevent the filter 601 from rotating during movement, and the design of the kidney-shaped hole is conducive to the positioning and movement of the filter 601. The outer contour of the holder matches the shape of the air outlet 310.

In some embodiments, the holder includes a peripheral frame, a support, and a probe rod. The support is located within the peripheral frame, and the end part of the support is fixedly connected to the peripheral frame. The probe rod is connected to the support. For example, the probe rod is connected to the center of the support and extends toward one side of the support facing away from the filter screen. The support may be provided in a “cross” shape, with its four peripheral end parts respectively connected fixedly to the peripheral frame, thereby proving excellent support for the filter screen and the peripheral frame. In addition, the probe rod is fixed at the center of the support. Pushing or pulling the probe rod can cause the peripheral frame to slide along the bottom wall of the outer drum 300 at the air outlet 310, thereby improving the stability of the filter 601 during movement.

In some embodiments, a driving mechanism is arranged on the outer drum and away from the inner drum, and the driving mechanism is used to drive the filter screen member to move. For example, the clothing treatment apparatus further includes a driving structure 13, which is in transmission connection with the filter 601 or the cleaning member 12. The driving structure 13 is used to drive the filter 601 or the cleaning member 12 to move. In an exemplary embodiment, the driving structure 13 is used to drive the filter 601 to move away from or close to the bottom wall of the inner drum 200, and the direction of movement is parallel to the axis along which the inner drum 200 rotates, such that the filter 601 can be selectively in contact with the cleaning member 12. The driving structure 13 is arranged on the outer drum 300, and the driving structure 13 is located on one side of the outer drum 300 facing away from the inner drum 200. In some embodiments, the driving structure 13 includes an electric driver. The acting end of the electric driver is connected to the probe rod, such that the filter 601 slides along the cylindrical hole in a reciprocating manner. In an exemplary embodiment, the driving structure 13 may further include a lead screw assembly. The lead screw assembly may include a nut and a lead screw matched with the nut. The electric driver may be a servo motor, an electric driving cylinder, or the like. The output shaft of the servo motor is connected to the lead screw via a coupling, and the nut is connected to the probe rod. When the servo motor is energized, the lead screw is driven to rotate, causing the nut to move along the lead screw, thereby driving the probe rod to move and thus driving the filter 601 to slide along the hole wall of the cylindrical hole. When the servo motor is de-energized, the movement of the filter 601 stops. Since the transmission utilizing the nut and lead screw has a self-locking function, the position of the filter 601 relative to the bottom wall of the inner drum 200 can be fixed. This allows the cleaning member 12 to make contact with the surface of the filter 601. In this way, during the continuous circumferential rotation of the inner drum 200, the cleaning member 12 intermittently sweeps across the surface of the filter 601, thereby removing the lint adhered to the filter 601. In addition, the driving structure 13 may further include a pair of gear sets. The driving gear is mounted on the output shaft of the servo motor, and the driven gear is mounted on the lead screw. The design of this gear set allows the axis of the output shaft of the servo motor to be perpendicular to the moving direction of the filter 601, thereby enabling a more compact mounting space for the driving structure 13. In order to protect the driving structure 13 from the impact of the humid airflow, a protective cover may be provided outside the driving structure 13. For ease of mounting and maintenance, the protective cover may extend to the outside of the air outlet duct 1300, and the servo motor and the like may be provided outside the air outlet duct 1300. The protective cover and the air outlet duct 1300 are designed with proper sealing.

During the rotation of the inner drum 200, the cleaning member 12 cleans the filter screen once each time the cleaning member rotates near the air outlet 310. The disadvantage is that the cleaning member 12 will intermittently contact the filter screen during the washing, spinning, and drying processes. However, in practice, the cleaning of the filter screen is required only during the spinning and drying processes, or only during the drying process. To address this issue, the applicant of the present disclosure has further proposed the following designs.

In some embodiments, the clothing treatment apparatus further includes: a detection sensor arranged in the air outlet duct 1300, where the detection sensor is used to detect the pressure of the humid airflow filtered by the filter 601; and a processor connected to both the driving structure 13 and the detection sensor. The detection sensor sends the detected pressure of the humid airflow to the processor, and the processor receives and processes the pressure of the humid airflow sent by the detection sensor. When the pressure of the humid airflow is lower than a preset threshold, the processor sends a control signal to the driving structure 13, such that the driving structure 13 drives the filter 601 to move in a direction close to the inner drum 200 along the cylindrical hole; when the pressure of the humid airflow is higher than the preset threshold, the processor sends a control signal to the driving structure 13, such that the driving structure 13 drives the filter 601 to move in a direction away from the inner drum 200 along the cylindrical hole. The detection sensor is arranged in the air outlet duct 1300 of the outer drum 300 to detect the condition of the humid airflow in the air outlet duct 1300, so as to determine whether excessive lint has been adhered to the surface of the filter 601. When the pressure of the humid airflow decreases to a certain threshold, it can be determined that excessive lint is adhered to the surface of the filter 601, which obstructs the humid airflow from entering the air outlet duct 1300. In this case, the driving structure 13 drives the filter 601 to move a certain distance toward the inner drum 200 and then stop, allowing the bristle strip to clean the filter; when the pressure of the humid airflow increases to a certain threshold, it can be determined that the surface of the filter 601 is not adhered with excessive lint, and the humid airflow can smoothly enter the air outlet duct 1300. In this case, the driving structure 13 drives the filter 601 to move in a direction away from the inner drum 200. This process is repeated in this manner.

In some embodiments, the clothing treatment apparatus further includes: a processor connected to the driving structure 13. When the washing or rinsing process starts, the processor sends a control signal to the driving structure 13, such that the driving structure 13 drives the filter 601 to move in a direction away from the inner drum 200 along the cylindrical hole; when the spinning or drying process starts, the processor sends a control signal to the driving structure 13, such that the driving structure 13 drives the filter 601 to move in a direction close to the inner drum 200 along the cylindrical hole. During the washing or rinsing process of the clothing, the driving structure 13 drives the filter 601 to move in a direction away from the inner drum 200 and remain fixed. In this case, the bristle strip does not contact the surface of the filter 601. When the spinning or drying process starts, the driving structure 13 drives the filter 601 to move in a direction close to the inner drum 200 and remain fixed. In this case, the bristle strip intermittently contacts the filter screen as the inner drum 200 rotates, thereby cleaning the filter screen.

The present disclosure provides a filter cleaning device. The filter cleaning device is configured to clean a treatment apparatus configured with a filter. The treatment apparatus configured with a filter may be any one of household or office treatment apparatuses such as a clothing treatment apparatus, an air conditioner, a purifier, an exhaust hood, an air filter, a dehumidifier, and a dust remover.

In one embodiment of the present disclosure, a clothing treatment apparatus is provided. The clothing treatment apparatus is configured to perform washing, rinsing, ironing, drying, and other treatments on clothing. The clothing treatment apparatus includes a filter and a filter cleaning device according to any one of the following embodiments. The clothing treatment apparatus includes, but is not limited to, a washing machine, a dryer, and a washer-dryer combination unit. FIG. 1 illustrates a clothing treatment apparatus 1000, which includes a clothing accommodating device 1100 configured to accommodate the clothing to be processed (which may be provided to include an inner drum and/or an outer drum), a drying device 2000, and an air outlet duct 1300. The air outlet duct 1300 connects the clothing accommodating device 1100 and the drying device 2000. The air outlet duct 1300 is configured to guide the airflow from the clothing accommodating device 1100 to the drying device 2000. The relative position between the clothing accommodating device 1100 and the drying device 2000 may be arranged either vertically or front-to-back, which is not limited by the present disclosure.

In one embodiment of the present disclosure, the humid airflow in the clothing accommodating device 1100 passes through the air outlet duct 1300 and then enters the drying device 2000. After being dried by the drying device 2000, the humid airflow re-enters the clothing accommodating device 1100, thereby forming a circulating airflow between the clothing accommodating device 1100 and the drying device 2000.

In one embodiment of the present disclosure, the drying device 2000 includes a moisture adsorption unit and a moisture desorption unit. The moisture adsorption unit is configured to adsorb the moisture in the airflow led out from the clothing accommodating device 1100. The moisture desorption unit is configured to desorb the moisture adsorbed by the moisture adsorption unit, thereby restoring the dehumidification capacity of the moisture adsorption unit. The filter 601 is arranged between the air outlet of the clothing accommodating device 1100 and the air inlet of the drying device 2000 to filter the airflow. In one embodiment, the filter cleaning device 6200 is arranged on a non-filtering surface of the filter 601 and is configured to clean the filter 601.

In one embodiment of the present disclosure, the drying device 2000 includes a moisture adsorption-desorption rotary disk. The moisture adsorption-desorption rotary disk is rotatable. The housing is configured to accommodate the moisture adsorption-desorption rotary disk. The internal space of the housing is divided into at least a moisture adsorption space and a moisture desorption space. The moisture adsorption-desorption rotary disk, when rotating into the moisture adsorption space, serves as a moisture adsorption unit. The moisture adsorption-desorption rotary disk, when rotating into the moisture desorption space, serves as a moisture desorption unit.

In one embodiment of the present disclosure, the drying device 2000 may include a moisture adsorption-desorption rotary disk and a driving part for driving the moisture adsorption-desorption rotary disk to rotate. The moisture adsorption-desorption rotary disk is provided with a moisture adsorption agent configured to adsorb moisture. The moisture adsorption agent may be zeolite, alkali metal aluminosilicate, lithium chloride, silica gel, modified silica gel, and activated alumina, among others. In one embodiment, the moisture adsorption agent may also be a material having moisture adsorption properties, such as a molecular sieve (including but not limited to a zeolite molecular sieve, an A/X/Y molecular sieve, a ZSM molecular sieve, and a Beta molecular sieve), and a polymeric moisture adsorption agent. The polymeric moisture adsorption agent is also referred to as a polymer adsorbent, which has a lower regeneration temperature than conventional silica gel, activated carbon, or a molecular sieve.

In one embodiment, the moisture adsorption-desorption rotary disk may be made of porous materials such as zeolite, molecular sieves, Metal Organic Frameworks (MOFs), Covalent Organic Frameworks (COFs), nanocarbon, and silicon dioxide.

In one embodiment, the moisture adsorption-desorption rotary disk may also be formed by filling with granular solids or particles made of at least one of the above porous materials.

In one embodiment, the moisture adsorption-desorption rotary disk may be a honeycomb-shaped or corrugated rotary disk carrying a moisture adsorption agent, capable of adsorbing and desorbing the adsorbed water vapor for repeated desorption and regeneration.

In one embodiment, the moisture adsorption-desorption rotary disk includes an inorganic/organic fiber carrier (e.g., ceramic, glass fiber, MOFs, COFs, or cordierite). The fiber carrier is coated with a moisture adsorption agent such as a molecular sieve. The molecular sieve is uniformly distributed between the fiber carriers and on the surface of the fiber carriers to adsorb the moisture from the airflow. The molecular sieve may include a single crystal molecular sieve such as an A-type molecular sieve, an X/Y-type molecular sieve, a ZSM molecular sieve, or a Beta molecular sieve, or a mixed crystal molecular sieve.

In one embodiment of the present disclosure, the moisture adsorption-desorption rotary disk is divided by a sealing system into a moisture adsorption zone and a regeneration zone. Under the drive of the driving part, the moisture adsorption-desorption rotary disk rotates slowly. When the humid airflow from the clothing accommodating device 1100 passes through the moisture adsorption zone of the moisture adsorption-desorption rotary disk, some of the moisture is adsorbed by the moisture adsorption medium in the rotary disk. The dried air that has passed through the moisture-adsorbing process enters the clothing accommodating device 1100 to dry the clothing therein. Meanwhile, the rotary disk gradually approaches saturation as it adsorbs a certain amount of moisture. In the regeneration zone of the moisture adsorption-desorption rotary disk, another stream of air may first pass through a heater, then become high-temperature air, and pass through the saturated rotary disk after the moisture adsorption. This causes the water adsorbed by the rotary disk to evaporate, thereby restoring the dehumidification capacity of the rotary disk. Typically, the humid air from the clothing accommodating device 1100 carries some impurities, such as lint shed from the clothes. If these impurities, like lint, are not filtered, the humid air would bring these impurities into the drying device 2000, where the impurities attach to the moisture adsorption-desorption rotary disk. This could result in clogging of the moisture adsorption-desorption rotary disk. Or, lint attached to the moisture adsorption-desorption rotary disk could ignite when passing through the heater, causing damage to the moisture adsorption-desorption rotary disk.

Therefore, in one embodiment of the present disclosure, as shown in FIGS. 1 and 8, a filter 601 may be arranged in the flow path of humid air within the clothing accommodating device 1100, so as to filter out the impurities such as lint. For example, the filter 601 may be arranged in the air outlet duct 1300, which connects the clothing accommodating device 1100 and the drying device 2000. For example, in order to increase the filtration area of the filter 601, the filter 601 may be arranged obliquely within the air outlet duct 1300. During the operational process of the clothing treatment apparatus, if the filter 601 is not cleaned for a long time, impurities such as lint attaching to the filter may clog the airflow within the air outlet duct 1300, thereby affecting the drying efficiency of the clothing treatment device.

In order to remove the impurities such as lint from the filter 601, in one embodiment of the present disclosure, a filter cleaning device 6200 is provided. The filter cleaning device is configured to clean the impurities attached to the filter 601. The filter cleaning device 6200 may be a spraying device that removes the impurities attached to the filter by spraying a cleaning solution.

In one embodiment, the clothing accommodating device 1100 includes an inner drum and an outer drum. The inner drum is configured to accommodate clothing, and the outer drum is arranged outside the inner drum with a certain distance therebetween. The diameter of the outer drum is greater than the diameter of the inner drum, the side wall of the inner drum is provided with water passage holes, and the outer drum is configured to accommodate the washing water. The air outlet of the clothing accommodating device 1100 is arranged on the rear wall of the outer drum. The length of the air outlet duct 1300 (denoted as L1 in FIG. 1) is greater than more than half of the diameter of the outer drum (denoted as D1 in FIG. 1). In this embodiment, the air outlet duct 1300 is relatively long, such that the area of the filter 601 can be appropriately increased, and the mounting space for the filter cleaning device 6200 can be increased.

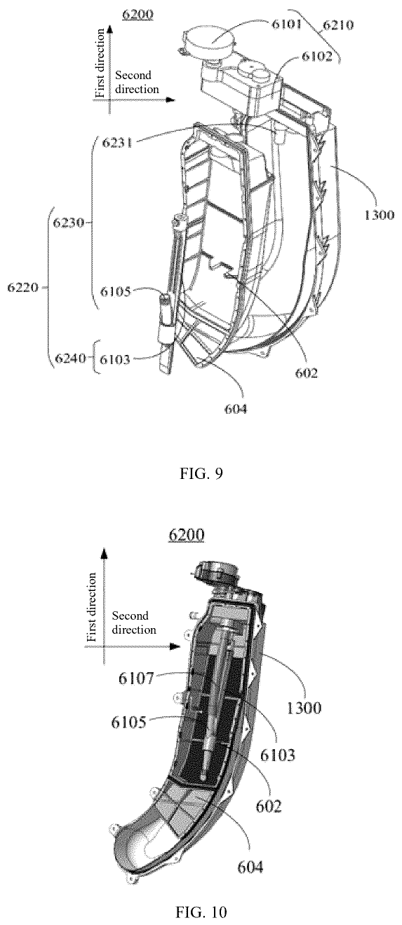

As shown in FIG. 9, in some embodiments of the present disclosure, the filter cleaning device 6200 may include a driving mechanism 6210 and a spraying mechanism 6220. The driving mechanism 6210 is configured to provide a driving force to drive the spraying mechanism 6220 to move. The spraying mechanism 6220 is connected to the water supply port of the treatment apparatus (the water supply port of the treatment apparatus is not shown in the figure) and is configured to spray the cleaning fluid onto the filter 601 or to a preset region of the filter.

The spraying mechanism 6220 includes a water supply assembly 6230 and a spray assembly 6240. The water supply assembly 6230 is connected to the water supply port of the treatment apparatus via the water inlet port 6231. The water supply assembly 6230 may include a flow-guiding structure configured to guide the cleaning fluid. The spray assembly 6240 is connected to the flow-guiding structure, and the spray assembly 6240 is provided with a plurality of spray ports 6241 spaced apart from each other. The flow-guiding structure can guide the flow path of the cleaning fluid toward the spray assembly 6240.

In this embodiment, the filter 601 may be arranged between the air outlet of the clothing accommodating device 1100 and the air inlet of the drying device 2000 to filter the airflow. The filter cleaning device 6200 may be arranged on the side of the non-filtering surface of the filter 601 and configured to clean the filter 601. The driving mechanism 6210 cooperates with the spraying mechanism 6220 to easily achieve the function of cleaning the filter 601.

Further, as shown in FIGS. 9 and 10, in one embodiment, the spraying mechanism 6220 includes a water supply assembly 6230 and a spray assembly 6240. The flow-guiding structure shown in FIG. 10 is a water supply connecting member 6107 (which may be configured as a water supply hose). The water supply assembly 6230 further includes a water supply pipe 6105. The water supply connecting member 6107 is connected to the water inlet port 6231, and the water supply pipe 6105 is connected to the water supply connecting member 6107. The spray assembly 6240 includes a spray head 6103. The plurality of spray ports 6241 spaced apart from each other are spray holes 6104, and the spray holes 6104 are arranged on the same surface of the spray head 6103. The water supply pipe 6105 and the spray holes 6104 are respectively arranged on two surfaces of the spray head 6103 facing away from each other.

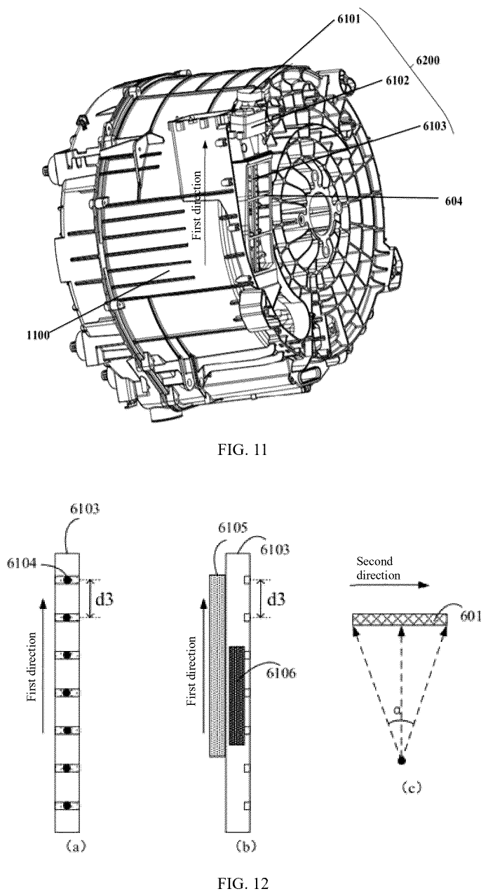

As shown in FIG. 9, the driving mechanism 6210 includes a drive motor 6101 and a transmission part, such as a gearbox 6102 shown in FIG. 9. The spraying mechanism 6220 includes a spray head 6103 and a water supply pipe 6105. The spray head 6103 may include one or more spray holes 6104 spaced apart from each other. For example, the structure of the spray head 6103 may be similar to that of a shower head. The spray holes 6104 may be arranged row by row from top to bottom or column by column from left to right. The spray holes 6104 may be arranged in one or more rows or in one or more columns. The spray holes 6104 may be arranged regularly, such as being equally spaced apart from each other, or may be arranged irregularly or distributed randomly according to a certain rule. The shortest distance between two adjacent spray holes 6104 is denoted as d3. FIG. 9 illustrates a filter cleaning device 6200, which includes a drive motor 6101, a gearbox 6102, a spray head 6103, a water supply pipe 6105, and a filter support 604 (a filter 601, which serves a filtration function, is arranged within the filter support 604). FIG. 11 illustrates a filter assembly (the filter assembly includes a filter 601; since FIG. 11 is a partial sectional view of the filter assembly, the filter 601 is not directly shown in FIG. 11) arranged on the outer wall of the clothing accommodating device 1100 and a filter cleaning device 6200 configured to clean the filter 601. The driving mechanism drives the spraying mechanism to move in a plurality of directions. For example, the driving mechanism drives the spraying mechanism to move in a first direction or a second direction, where the first direction and the second direction are perpendicular to each other. For example, the drive motor 6101 cooperates with the gearbox 6102 to allow the spraying mechanism 6220 to move in the first direction (the length direction of the spraying mechanism 6220), thereby allowing the cleaning fluid (spraying fluid, which may be water or water with an added detergent) to cover the upper and lower ends of the filter 601 in the first direction. The spraying mechanism 6220 may rotate around a rotation axis, enabling the spraying fluid to cover both the left and right ends of the filter 601 in the second direction.

In one embodiment, the specific structure of the spray head 6103 is illustrated in FIG. 12. FIG. 12(a) is a front view of the spray head 6103, showing the front surface of the spray head 6103, that is, the surface of the spray head 6103 facing the filter 601 (directly confronting the filter 601). FIG. 12(b) is a side view of the spray head 6103. The movement distance of the spraying mechanism 6220 in the first direction (i.e., the arrangement direction of the plurality of spray holes) is greater than or equal to the shortest distance d3 between two adjacent spray holes 6104, such that the filter 601 can be directly sprayed by the spraying fluid in the first direction, thereby ensuring that the filter cleaning device 6200 can clean the filter 601 more thoroughly.

In one embodiment, the spray head 6103 is rotatable, allowing the sprayed fluid to cover the filter 601 in the second direction. In this embodiment, the rotation of the spray head 6103 may be driven by the drive motor 6101 and the gearbox 6102. This enables the spray holes 6104 to rotate at a preset rate, thereby removing lint and impurities attached to the filter 601.

The spraying mechanism 6220 may move in the length direction of the spraying mechanism 6220, such that the spraying fluid covers the filter 601 in the first direction. The length direction of the spraying mechanism 6220 is the first direction. The spraying mechanism 6220 rotates by a first angle with the first direction as its axis (the rotation axis of the spraying mechanism 6220 is parallel to the first direction) to expand the area of the filter 601 covered by the spraying fluid.

In one embodiment, as shown in FIG. 12(c), the first angle α ranges from 5° to 45°. In FIG. 12(c), the first direction is defined as the direction extending from the inside to the outside, which is perpendicular to the paper surface and points into the paper surface. Specifically, the first angle α may be set to 5°, 12°, 16°, 19°, 24°, 28°, 31°, 37°, 42°, 45°, or other angles. The rotation angle of the first angle α may be selected based on the varying widths of the filter 601. In this embodiment, the movement of the spraying mechanism 6220 enables the spraying fluid to cover 80% or more of the region of the filter 601.

In one embodiment, the spraying mechanism 6220 further includes a switch configured to open or close one or more of the plurality of spray holes. The switch can control the opening or closing of the spray holes. The switch may be configured as an integrally formed structure or as a plurality of discrete structures. As shown in FIG. 12, the spraying mechanism 6220 includes a first blocking block 6106. The first blocking block 6106 is arranged on one surface of the spray head 6103 away from the water supply pipe 6105 and is configured to block one or more of the plurality of spray holes 6104. The spray head 6103 is provided with a cavity, and the first blocking block 6106 is arranged within the cavity. The first blocking block 6106 can move up and down. The first blocking block 6106 can move up and down in the first direction. In the practical application process of the filter cleaning device 6200 in the clothing treatment apparatus, the relative position between the spraying mechanism 6220 and the filter 601 may be arranged as the first position, that is, the spraying mechanism 6220 and the filter 601 are arranged in parallel and spaced apart from each other in the first direction. The specific distance of the parallel spacing may be adjusted according to different air outlet ducts 1300. With continued reference to FIG. 12(b), the first blocking block 6106 can initially cover some of the lower spray holes 6104. On the one hand, this increases the water pressure of the upper spray holes 6104, achieving the maximum cleaning effect on the upper filter 601. On the other hand, during the cleaning process of the upper filter 601, some lint and impurities at the lower part of the filter 601 may also be carried away by the filtered water. Once the lint and impurities on the upper filter 601 are fully cleaned, the first blocking block 6106 slowly moves downward, exposing more spray holes 6104 to further wash away the lint and impurities in the middle and lower parts of the filter 601. Ultimately, the filter 601 can be cleaned using varying water pressures. Specifically, the number of spray holes 6104 that can spray fluid (spray volume), the speed of the spraying fluid in the spray holes 6104 (spray velocity), and the pressure of the spraying fluid in the spray holes 6104 (spray pressure) can be controlled by arranging a faucet/water valve.

In this embodiment, the spray volume, spray velocity, spray pressure, and spray angle of the spraying mechanism 6220 can all be adjusted, thereby enhancing the cleaning effect of the spraying mechanism 6220 on the filter 601.

In one embodiment, the spraying mechanism 6220 is located on a first plane formed by the first direction and the second direction. The angle between the first plane and the plane of the filter 601 is less than 90°. For example, the first plane is parallel to the plane of the filter 601. In this case, the spraying mechanism 6220 does not make any contact with the filter 601. When the angle between the first plane and the plane of the filter 601 is greater than 0° but less than 90°, the end of the filter 601 close to the clothing accommodating device (i.e., the lower end of the spraying mechanism 6220) can be arranged to make contact with the spraying mechanism 6220.

In one embodiment, the distance between the spraying mechanism 6220 and the filter 601 is within the range of 0.4 cm to 1 cm. For example, the distance between the spraying mechanism 6220 and the filter 601 may be set to 0.4 cm, 0.54 cm, 0.65 cm, 0.84 cm, 0.93 cm, 1 cm, or other values. The distance between the spraying mechanism 6220 and the filter 601, according to this embodiment, is a rational design based on parameters such as the spraying range of the spraying mechanism 6220 and the spatial arrangement of the clothing treatment apparatus.

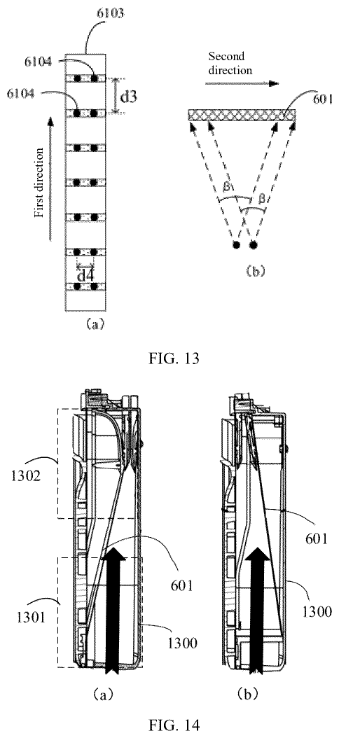

In one embodiment, as shown in FIG. 13, FIG. 13(a) illustrates the front surface of the spray head 6103, i.e., the surface of the spray head 6103 facing the filter 601. A plurality of rows/columns of spray holes 6104 can be arranged on the spray head 6103. The spray holes 6104 may be arranged row by row from top to bottom or column by column from left to right. In the first direction, the shortest distance between two adjacent spray holes 6104 is denoted as d3. In the second direction, the shortest distance between two adjacent spray holes 6104 is denoted as d4. The value ranges for d3 and d4 may be identical. In FIG. 13(b), the direction facing the paper surface is the first direction. The rotation angle of the spray holes 6104 around the rotation axis is the second angle β. Given the determined width of the filter 601, the range of the second angle β may be less than the first angle α; for example, the second angle β may be set between 3° to 40°.

In this embodiment, the spraying mechanism 6220 includes a plurality of spray holes 6104 configured to spray water. The spray holes 6104 may be configured as spray holes 6104 arranged row by row from top to bottom or column by column from left to right. The displacement of the spraying mechanism 6220 in the first direction is greater than or equal to the minimum distance between two spray holes 6104. The swinging angle of the spraying mechanism 6220 around the rotation axis (the first angle α and/or the second angle β) enables the spraying fluid to reach the edges of the length and/or width of the filter 601. In one embodiment, the spraying fluid of the spraying mechanism 6220 reaches at least 80% of the area of the filter 601. In one embodiment, the spraying fluid from the spraying mechanism 6220 reaches at least 90% of the length of the filter 601. Alternatively, the spraying fluid from the spraying mechanism 6220 reaches at least 90% of the width of the filter 601.

In one embodiment, the clothing treatment apparatus further includes a drive motor 6101 and a gearbox 6102. The drive motor 6101 drives the gearbox 6102 to enable the movement of the spraying mechanism 6220 along the length direction thereof, and the drive motor 6101 drives the gearbox 6102 to enable the spraying mechanism 6220 to rotate along a direction perpendicular to the length direction thereof.

In one embodiment, as shown in FIG. 14, the air outlet duct 1300 includes a first end part 1301 close to the clothing accommodating device and a second end part 1302 close to the drying device 2000, and the filter 601 is arranged to span across the first end part 1301 and the second end part 1302 of the air outlet duct 1300.

In this embodiment, if the air outlet duct 1300 is of a cylindrical structure, the filter 601 is of a mesh structure with elliptical small holes. The filter 601 spans across the first end part 1301 and the second end part 1302 of the air outlet duct 1300. Specifically, the filter 601 has a contact surface with the pipe wall of the first end part 1301, and the filter 601 also has a contact surface with the pipe wall of the second end part 1302. In this embodiment, the arrangement mode of the filter 601 allows the airflow within the air outlet duct 1300 to undergo thorough filtration.

In one embodiment, the spraying mechanism 6220 is arranged to span across the first end part 1301 and the second end part 1302 of the air outlet duct 1300, thereby facilitating more convenient spray cleaning of the filter 601.

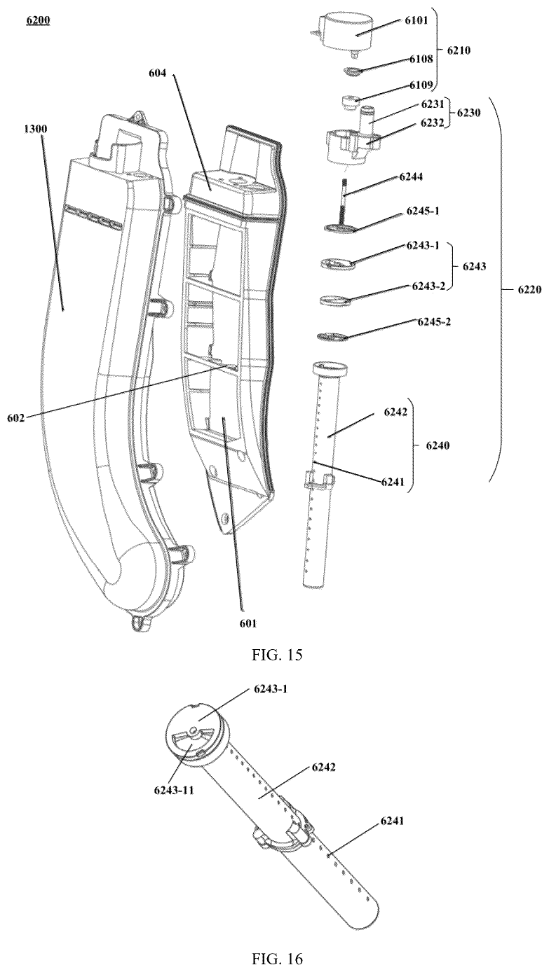

As shown in FIG. 15, in one embodiment, the water supply assembly 6230 includes a water inlet port 6231 and a water inlet device 6232. The water supply assembly 6230 is connected to the water supply port of the treatment apparatus via the water inlet port 6231. The water inlet device 6232 is connected to the water inlet port 6231 and is configured to provide a cleaning fluid to the spray assembly 6240. The water inlet device 6232 may include a water inlet joint. The water inlet joint and the water inlet port 6231 may be arranged in an aligned manner, or the water inlet joint and the water inlet port 6231 may be arranged in a staggered manner.

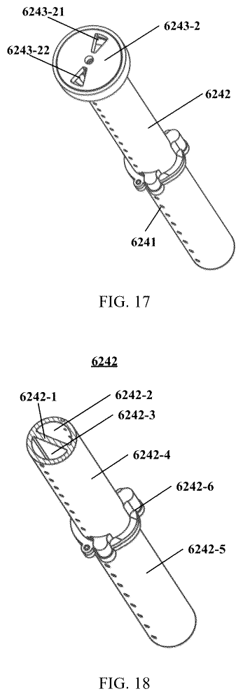

As shown in FIGS. 16 and 17, the spray assembly 6240 includes a spray pipe 6242. The spray pipe 6242 is connected to the water inlet device 6232. The spray pipe 6242 is provided with a plurality of spray ports 6241 spaced apart from each other and is configured to spray the cleaning fluid from the spray ports 6241. The shape of the spray pipe 6242 is not limited and may be configured as cylindrical, polyhedral (such as tetrahedral, hexahedral, and octahedral), or other shapes. The length of the spray pipe 6242 is also not limited and may be specifically determined based on the mounting position of the filter 601 and the actual mounting space on the treatment apparatus.

In this embodiment, the specific structural form and connection mode of the water supply assembly 6230 and the spray assembly 6240 are provided. The simple and effective structure can reduce the volume of the filter cleaning device 6200, save space, and facilitate the mounting near the filter 601.

In one embodiment, the flow-guiding structure is a water distributor 6243. The water distributor 6243 is connected to the water inlet device 6232, and the water distributor 6243 is configured to guide the cleaning fluid to the spray pipe 6242. In this embodiment, the water distributor 6243 is arranged such that on the one hand, the water distributor 6243 is connected to the water inlet device 6232 and is configured to guide the path of the cleaning fluid, and on the other hand, the water distributor 6243 is connected to the spray pipe 6242 and is configured to control the flow rate and/or flow velocity of the cleaning fluid entering the spray pipe 6242.

As shown in FIG. 16, in one embodiment, the water distributor 6243 includes a first water dividing plate 6243-1 (which may be configured as a fixed plate or a stationary plate). The first water dividing plate 6243-1 may be provided with a first through hole 6243-11, and the cleaning fluid flows out from the first through hole 6243-11. In this embodiment, providing the first through hole 6243-11 on the first water dividing plate 6243-1 facilitates the control of the flow rate and/or the flow velocity of the cleaning fluid entering the spray pipe 6242. Specifically, the area of the first through hole 6243-11 accounts for 10% to 90% of the area of the first water dividing plate 6243-1. For example, the area of the first through hole 6243-11 may be configured to be half of the area of the first water dividing plate 6243-1. Alternatively, the area of the first through hole 6243-11 may be configured to be one-third of the area of the first water dividing plate 6243-1.

As shown in FIG. 17, in one embodiment, the water distributor 6243 further includes a second water dividing plate (movable plate) 6243-2 (which may be configured as a movable plate). The second water dividing plate 6243-2 can move relative to the first water dividing plate 6243-1. The second water dividing plate 6243-2 is provided with at least a first water dividing hole 6243-21 and a second water dividing hole 6243-22. The cleaning fluid in the first through hole 6243-11 flows to the spray pipe 6242 via the first water dividing hole 6243-21 or the second water dividing hole 6243-22.

In this embodiment, the water distributor 6243 includes one movable water dividing plate and one stationary water dividing plate. The second water dividing plate 6243-2 can move relative to the first water dividing plate 6243-1, which enables the cleaning fluid to enter the spray pipe 6242 via the first through hole 6243-11 and the first water dividing hole 6243-21, or enables the cleaning fluid to enter the spray pipe 6242 via the first through hole 6243-11 and the second water dividing hole 6243-22. In this embodiment, the arrangement of the water distributor 6243 allows for appropriate adjustment of the flow velocity and/or the flow rate of the cleaning fluid after it enters the spray pipe 6242. For example, the flow rate of the cleaning fluid entering the spray pipe 6242 can be reduced. For another example, the flow velocity of the cleaning fluid after entering the spray pipe 6242 can be increased.

In one embodiment, when the second water dividing plate 6243-2 (movable plate) moves relative to the first water dividing plate 6243-1 (fixed plate), there are at least a first position and a second position. The first position is the position where the first water dividing hole 6243-21 and the first through hole 6243-11 have an overlapping projection area in the first direction. The second position is the position where the second water dividing hole 6243-22 and the first through hole 6243-11 have an overlapping projection area in the first direction. The first direction is the direction in which the length of the spray pipe 6242 extends.

In this embodiment, during the use of the filter cleaning device 6200, the first water dividing plate 6243-1 (fixed plate) is fixed, and the second water dividing plate 6243-2 (movable plate) and the spray pipe 6242 rotate together at a first speed. When the first water dividing hole 6243-21 is rotated to a position where it has an overlapping projection area with the first through hole 6243-11 in the first direction, the cleaning fluid in the first through hole 6243-11 flows to the rotary spray pipe 6242 via the first water dividing hole 6243-21. When the second water dividing hole 6243-22 is rotated to a position where it has an overlapping projection area with the first through hole 6243-11 in the first direction, the cleaning fluid in the first through hole 6243-11 flows to the spray pipe 6242 via the second water dividing hole 6243-22.

As shown in FIG. 18, in one embodiment, the spray pipe 6242 is provided with a hollow structure, and a partition member 6242-1 is arranged inside the spray pipe 6242. The partition member 6242-1 is configured to divide the spray pipe 6242 into a first spray sub-pipe 6242-2 and a second spray sub-pipe 6242-3. In this embodiment, the second water dividing plate 6243-2 (movable plate) and the spray pipe 6242 rotate together at the first speed (the second water dividing plate 6243-2 remains stationary relative to the spray pipe 6242). Moreover, the position of the first water dividing hole 6243-21 corresponds to the position of the first spray sub-pipe 6242-2. The position of the second water dividing hole 6243-22 corresponds to the position of the second spray sub-pipe 6242-3.

As shown in FIG. 15, in one embodiment, the water inlet device 6232 and the drive motor 6101 are connected by a driving connection member 6109. A motor sealing ring 6108 is arranged on the driving shaft of the drive motor 6101, and the motor sealing ring 6108 is arranged between the drive motor 6101 and the driving connection member 6109. One end of the connecting shaft 6244 is in a threaded connection with the driving connection member 6109, and the other end of the connecting shaft 6244 is in a threaded connection with the spray pipe 6242. The water inlet device 6232, the first sealing ring 6245-1, the first water dividing plate 6243-1, the second water dividing plate (movable plate) 6243-2, and the second sealing ring 6245-2 are sequentially arranged along the axis of the connecting shaft 6244 from the driving connection member 6109 to the spray pipe 6242. The water inlet device 6232, the first sealing ring 6245-1, the first water dividing plate 6243-1, the second water dividing plate (movable plate) 6243-2, and the second sealing ring 6245-2 are all sleeved on the connecting shaft 6244. The connecting shaft 6244 may rotate relative to the water inlet device 6232. The inner wall of the water inlet device 6232 is provided with a protrusion. The outer edges of the first sealing ring 6245-1 and the first water dividing plate 6243-1 are provided with slots. The first sealing ring 6245-1 is arranged between the inner wall of the water inlet device 6232 and the first water dividing plate 6243-1, and the first sealing ring 6245-1 and the first water dividing plate 6243-1 are snap-fitted on the inner wall of the water inlet device 6232. The connecting shaft 6244 is rotatable relative to the first sealing ring 6245-1 and the first water dividing plate 6243-1. The inner wall of the spray pipe 6242 is provided with a protrusion. The outer edges of the second water dividing plate (movable plate) 6243-2 and the second sealing ring 6245-2 are provided with slots. The second sealing ring 6245-2 is arranged between the second water dividing plate (movable plate) 6243-2 and the spray pipe 6242, and the second water dividing plate (movable plate) 6243-2 and the second sealing ring 6245-2 are snap-fitted on the inner wall of the spray pipe 6242. The second water dividing plate (movable plate) 6243-2 and the second sealing ring 6245-2 rotate along with the rotation of the connecting shaft 6244.

In one embodiment, the water distributor 6243 only includes the first water dividing plate 6243-1 provided with the first through hole 6243-11. The cleaning fluid flows out from the first through hole 6243-11 and then flows into the spray pipe 6242. The spray pipe 6242 is provided with a partition member 6242-1. As the spray pipe 6242 rotates, the cleaning fluid flows out from the spray port 6241 on the pipe wall of the spray pipe 6242 to spray the filter 601.

In one embodiment, the bottom end of the spray pipe 6242 is closed, which is more conducive to the accumulation of the cleaning fluid in the spray pipe 6242 and enables more powerful flushing of the filter 601.

In one embodiment, the first water dividing hole 6243-21 is located upstream of the first spray sub-pipe 6242-2, and the sectional area of the first water dividing hole 6243-21 is less than or equal to the sectional area of the first spray sub-pipe 6242-2. The second water dividing hole 6243-22 is located upstream of the second spray sub-pipe 6242-3, and the sectional area of the second water dividing hole 6243-22 is less than or equal to the sectional area of the second spray sub-pipe 6242-3.

In one embodiment, the sectional area of the first water dividing hole 6243-21 and/or the second water dividing hole 6243-22 accounts for 10% to 90% of the sectional area of the first through hole 6243-11. For example, the sectional area of the first water dividing hole 6243-21 may be configured to account for 60% of the sectional area of the first through hole 6243-11, and the sectional area of the second water dividing hole 6243-22 may be configured to account for 60% of the sectional area of the first through hole 6243-11. Alternatively, the sectional area of the first water dividing hole 6243-21 may be configured to account for 45% of the sectional area of the first through hole 6243-11, and the sectional area of the second water dividing hole 6243-22 may be configured to account for 45% of the sectional area of the first through hole 6243-11.

In one embodiment, in the first direction, the pipe wall of the first spray sub-pipe 6242-2 and the pipe wall of the second spray sub-pipe 6242-3 are each provided with the spray ports 6241 that are spaced apart from each other. In this embodiment, on the pipe wall of the first spray sub-pipe 6242-2 and the pipe wall of the second spray sub-pipe 6242-3, the spray ports 6241 may be arranged in one row and/or one column, or the spray ports 6241 may be arranged in a plurality of rows and/or a plurality of columns in an aligned or staggered manner.

In one embodiment, the line connecting the spray port 6241 to the central axis of the rotary spray pipe 6242 is perpendicular to the extension plane of the partition member 6242-1. In this embodiment, if the spray pipe 6242 is cylindrical, the spray port 6241 is arranged on the side wall of the first spray sub-pipe 6242-2 that is farthest away from the partition member 6242-1.

In one embodiment, in the first direction, the pipe wall of the first spray sub-pipe and the pipe wall of the second spray sub-pipe are each provided with spray ports spaced apart from each other. The spray ports 6241 of the first spray sub-pipe and the spray ports 6241 of the second spray sub-pipe are arranged in a staggered manner. In this embodiment, the spray ports 6241 located on the side wall of the first spray sub-pipe and the spray ports 6241 located on the side wall of the second spray sub-pipe are not at the same horizontal height. The spray ports 6241 are arranged in a staggered manner, which allows for a larger spray area.

In one embodiment, the spray pipe 6242 includes at least a first section of the spray pipe 6242-4 and a second section of the spray pipe 6242-5. Both the first section of the spray pipe 6242-4 and the second section of the spray pipe 6242-5 are provided with beveled surfaces. The beveled surface of the first section of the spray pipe 6242-4 is connected to the beveled surface of the second section of the spray pipe 6242-5. The beveled surface of the first section of the spray pipe 6242-4 and the beveled surface of the second section of the spray pipe 6242-5 are adapted to the position of the spray port 6241.

In this embodiment, the beveled surface of the first section of the spray pipe 6242-4 and the beveled surface of the second section of the spray pipe 6242-5 being adapted to the position of the spray port 6241 can be understood as follows: When the beveled surface of the first section of the spray pipe 6242-4 is connected to the beveled surface of the second section of the spray pipe 6242-5, the position of the spray port 6241 is avoided, such that the spray ports 6241 arranged in the pipe wall of each section of the spray pipe 6242 remain intact and orderly. Further, when the beveled surface of the first section of the spray pipe 6242-4 is connected to the beveled surface of the second section of the spray pipe 6242-5, the connection may be achieved by adhesive bonding, or by a connecting part 6242-6 as shown in FIG. 12 (for example, the connecting part 6242-6 may be arranged as a clamp).

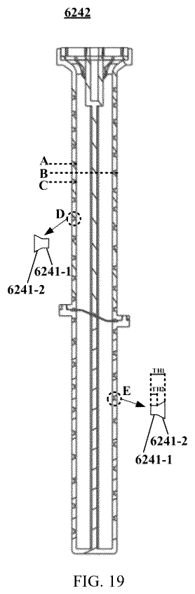

As shown in FIG. 19, in one embodiment, the spray port 6241 includes a first hole segment 6241-1 and a second hole segment 6241-2 in the thickness direction of the pipe wall of the spray pipe 6242. The second hole segment 6241-2 is arranged on one side of the first hole segment 6241-1 away from the rotation axis of the spray pipe 6242, and the diameter of the first hole segment 6241-1 is less than the diameter of the second hole segment 6241-2. FIG. 19 illustrates five spray ports 6241 A, B, C, D, and E. The three spray ports 6241 A, B, and C illustrate that the spray port 6241 located on the side wall of the first spray sub-pipe 6242-2 and the spray port 6241 located on the side wall of the second spray sub-pipe 6242-3 are not at the same horizontal height; that is, the spray ports 6241 are arranged in a staggered manner. In FIG. 19, the two spray ports 6241 D and E are enlarged, and it can be clearly seen in the enlarged view that the diameter of the first hole segment 6241-1 is less than the diameter of the second hole segment 6241-2. Specifically, the diameter of the first hole segment may be set to range from 0.2 mm to 3 mm; the diameter of the second hole segment may be set to range from 0.3 mm to 5 mm. In this embodiment, on the one hand, the smaller diameter of the first hole segment 6241-1 can help to maintain sufficient water pressure as the cleaning fluid passes through the first hole segment 6241-1, thereby enabling outward spraying through the second hole segment 6241-2; on the other hand, the larger diameter of the second hole segment 6241-2 can help to form a larger spray area.

In one embodiment, the thickness of the spray pipe 6242 is denoted as TH1, and the thickness of the first hole segment 6241-1 is denoted as TH2, where TH1>TH2>⅝TH1. Specifically, the thickness of the pipe wall of the spray pipe 6242 may be set to range from 0.3 mm to 5 mm (i.e., 0.3 mm≤TH1≤5 mm). For example, in one embodiment, the thickness of the rotary spray pipe 6242 is 1.6 mm, and the thickness of the first hole segment 6241-1 is 1.0 mm.

In one embodiment, the driving mechanism 6210 includes a drive motor 6101, which is configured to drive the spray pipe 6242 to rotate around the rotation axis of the spray pipe 6242, with a rotation angle of 60° to 360°.

In this embodiment, the drive motor 6101 drives the spray pipe 6242 to rotate circumferentially around the rotation axis of the spray pipe 6242 (the specific rotation angle is not limited). Further, the drive motor 6101 may drive the spray pipe 6242 to rotate clockwise and/or counterclockwise around the rotation axis of the spray pipe 6242 by an angle of 60° to 360°. For example, the rotation angle of the spray pipe 6242 is 90°, 180°, 270°, or 360°, etc. In one embodiment, the drive motor 6101 drives the rotary spray pipe 6242 to rotate by 360°. In another embodiment, the drive motor 6101 cooperates with structures such as the connecting rod to limit the rotary spray pipe 6242, so as to control the rotary spray pipe 6242 to rotate in a reciprocating manner within a range of 180°.

In one embodiment, the driving mechanism 6210 includes a telescopic drive motor 6101, which is configured to drive the spray pipe 6242 to move up and down along the length extension direction of the spray pipe 6242. In this embodiment, a vertical movement space is reserved in the air outlet duct 1300 for the filter cleaning device 6200, and the spray pipe 6242 is further configured to move up and down.

In one embodiment, the filter 601 includes a filtering surface and a non-filtering surface that are opposite to each other. The filtering surface is the surface of the filter 601 that the airflow first contacts. The non-filtering surface is the surface through which airflow exits the filter 601. The spraying mechanism 6220 is arranged on the side of the non-filtering surface and is arranged to face the filter 601, enabling the removal of lint and impurities filtered by the filter 601 from the side of the non-filtering surface.

In one embodiment, the distance between the spraying mechanism 6220 and the filter 601 is within the range of 0.4 cm to 1 cm. In this embodiment, the spraying mechanism 6220 and the filter 601 are arranged in parallel or at a small angle of approximately 4°.

In one embodiment, the surface of the spray assembly 6240 facing the filter 601 is a flat surface or a curved surface.

In this embodiment, the shape of the spray assembly 6240 is not limited, and the spray assembly 6240 (the spray head 6103 or the spray pipe 6242) may have a polygonal structure, such as an octagon, a hexagon, or a quadrangle. In this embodiment, the surface of the spray assembly 6240 facing the filter 601 is a flat surface. The spray assembly 6240 (the spray head 6103 or the spray pipe 6242) may also be a curved surface, such as a spherical spray head 6103 or a cylindrical spray pipe 6242, among other structures. In this embodiment, the surface of the spray assembly 6240 facing the filter 601 is a curved surface.

In the embodiments shown in FIGS. 9 to 19, the spraying mechanism 6220 sprays the cleaning fluid onto the filter 601, with the spray area being greater than or equal to 80% of the filtration area of the filter 601.

In one embodiment, as shown in FIGS. 9 and 10, the filter 601 is provided with a limiting member 602, which is configured to limit the movement of the spraying mechanism 6220 (the spray head 6103 and/or the spray pipe 6242) within a preset range.

In this embodiment, the preset range refers to the value range of deviation from the original position during vertical movement or circumferential rotation, which serves to prevent the spraying mechanism 6220 (the spray head 6103 and/or the spray pipe 6242) from misaligning or deviation.

In any one of the groups of embodiments/any one of the embodiments described above in the present disclosure, one or more features involved may be combined with each other to achieve the thorough cleaning of the filter in the treatment apparatus.

The above are only preferred embodiments of the present disclosure and are not intended to limit the present disclosure. For those skilled in the art, the present disclosure can be modified and varied. Any modification, equivalent substitution, improvement, and the like made within the spirit and principle of the present disclosure shall all fall within the protection scope of the present disclosure. It should be noted that similar reference numerals and letters refer to similar items in the following drawings, and thus, once an item is defined in one of the drawings, it does not need to be further defined or explained in the subsequent drawings.

The above descriptions are only embodiments of the present disclosure, but the protection scope of the present disclosure is not limited thereto. Any variations or substitutions that can be easily conceived by those skilled in the art within the technical scope disclosed in the present disclosure shall fall within the protection scope of the present disclosure. Therefore, the protection scope of the present disclosure shall be subject to the protection scope of the claims.

1. A filter cleaning device, configured to clean a treatment apparatus configured with a filter,
the filter cleaning device comprising: a driving mechanism and a spraying mechanism, wherein
the driving mechanism is configured to provide a driving force to drive the spraying mechanism to move;
the spraying mechanism is connected to a water supply port of the treatment apparatus and is configured to spray a cleaning fluid onto the filter;
the spraying mechanism comprises a water supply assembly and a spray assembly, wherein
the water supply assembly is connected to the water supply port, and the water supply assembly comprises a flow-guiding structure configured to guide the cleaning fluid; and
the spray assembly is connected to the flow-guiding structure, and the spray assembly is provided with a plurality of spray ports spaced apart from each other.

2. The filter cleaning device according to claim 1, wherein the flow-guiding structure is a water supply connecting member; the water supply assembly further comprises: a water supply pipe;
the water supply connecting member is connected to the water supply port, and the water supply pipe is connected to the water supply connecting member;
the spray assembly comprises: a spray head; the plurality of spray ports spaced apart from each other are spray holes, and the spray holes are arranged on a same surface of the spray head; and
the water supply pipe and the spray holes are respectively arranged on two surfaces of the spray head facing away from each other.

3. The filter cleaning device according to claim 2, wherein the spray holes are spaced apart from each other along a first direction; and
a movement distance of the spraying mechanism in the first direction is greater than or equal to a minimum distance between two adjacent spray holes; and/or
wherein a rotation angle of the spraying mechanism ranges from 5° to 45°.

4. (canceled)

5. The filter cleaning device according to claim 2, wherein the spraying mechanism further comprises a switch configured to open or close one or more of the spray holes; and/or
the spraying mechanism comprises a first blocking block, the first blocking block is arranged on one surface of the spray head away from the water supply pipe and is configured to block one or more of the plurality of spray holes.

6. The filter cleaning device according to claim 1, wherein the water supply assembly further comprises a water inlet port and a water inlet device, and the water inlet port is connected to the water supply port;
the spray assembly comprises a spray pipe, and the spray pipe is connected to the water inlet device; the spray pipe is provided with a plurality of spray ports spaced apart from each other and is configured to spray the cleaning fluid from the spray ports; and
the flow-guiding structure is a water distributor, and the water distributor is connected to the water inlet device and is configured to guide the cleaning fluid to the spray pipe.

7. The filter cleaning device according to claim 6, wherein the water distributor comprises: a first water dividing plate, the first water dividing plate being provided with a first through hole, and the cleaning fluid flowing out from the first through hole.

8. (canceled)

9. (canceled)

10. (canceled)

11. The filter cleaning device according to claim 7, wherein the water distributor further comprises: a second water dividing plate, the second water dividing plate moving relative to the first water dividing plate, the second water dividing plate being provided with at least a first water dividing hole and a second water dividing hole, and the cleaning fluid in the first through hole flowing to the spray pipe via the first water dividing hole or the second water dividing hole.

12. The filter cleaning device according to claim 11, wherein when the second water dividing plate moves relative to the first water dividing plate, there are at least a first position and a second position; the first position is a position where the first water dividing hole and the first through hole have an overlapping projection area in a first direction; the second position is a position where the second water dividing hole and the first through hole have an overlapping projection area in the first direction; and the first direction is a direction in which a length of the spray pipe extends.

13. The filter cleaning device according to claim 12, wherein the spray pipe is provided with a hollow structure, and a partition member is arranged inside the spray pipe; the partition member is configured to divide the spray pipe into a first spray sub-pipe and a second spray sub-pipe.

14. The filter cleaning device according to claim 13, wherein the first water dividing hole is located upstream of the first spray sub-pipe, and a sectional area of the first water dividing hole is less than or equal to the sectional area of the first spray sub-pipe; the second water dividing hole is located upstream of the second spray sub-pipe, and the sectional area of the second water dividing hole is less than or equal to the sectional area of the second spray sub-pipe.

15. The filter cleaning device according to claim 13, wherein in the first direction, the pipe wall of the first spray sub-pipe and a pipe wall of the second spray sub-pipe are each provided with the spray ports spaced apart from each other; a line connecting the spray ports to a central axis of the rotary spray pipe is perpendicular to an extension plane of the partition member; and/or
in the first direction, the pipe wall of the first spray sub-pipe and the pipe wall of the second spray sub-pipe are each provided with the spray ports spaced apart from each other; the spray ports of the first spray sub-pipe and the spray ports of the second spray sub-pipe are arranged in a staggered manner in the first direction.

16. The filter cleaning device according to claim 13, wherein the spray pipe comprises at least a first section of the spray pipe and a second section of the spray pipe; both the first section of the spray pipe and the second section of the spray pipe are provided with beveled surfaces; the beveled surface of the first section of the spray pipe is connected to the beveled surface of the second section of the spray pipe, and the beveled surface of the first section of the spray pipe and the beveled surface of the second section of the spray pipe are adapted to a position of the spray port.

17. The filter cleaning device according to claim 6, wherein along a thickness direction of a pipe wall of the spray pipe, the spray port comprises a first hole segment and a second hole segment, the second hole segment is arranged on one side of the first hole segment away from a rotation axis of the spray pipe, and a diameter of the first hole segment is less than the diameter of the second hole segment.

18. The filter cleaning device according to claim 17, wherein the thickness of the spray pipe is denoted as TH1, and a thickness of the first hole segment is denoted as TH2, where TH1>TH2>⅝TH1.

19. The filter cleaning device according to claim 6, wherein the driving mechanism comprises a drive motor, which is configured to drive the spray pipe to rotate around a rotation axis of the spray pipe, with a rotation angle of 60° to 360°; and/or
the driving mechanism comprises a telescopic drive motor, which is configured to drive the spray pipe to move up and down along a length extension direction of the spray pipe.

20. The filter cleaning device according to claim 1, wherein a surface of the spray assembly facing the filter is a flat surface or a curved surface; and/or
wherein a distance between the spraying mechanism and the filter is within a range of 0.4 cm to 1 cm; and/or
wherein the spraying mechanism sprays cleaning fluid onto the filter, with a spray area being greater than or equal to 80% of a filtration area of the filter; and/or
wherein the filter is provided with a limiting member, which is configured to limit a movement of the spraying mechanism within a preset range.

21. A clothing treatment apparatus, comprising: a clothing accommodating device, a drying device, a filter, and the filter cleaning device according to claim 1, wherein
the drying device comprises a moisture adsorption unit and a moisture desorption unit, the moisture adsorption unit being configured to adsorb moisture in an airflow led out from the clothing accommodating device, and the moisture desorption unit being configured to desorb the moisture adsorbed by the moisture adsorption unit;
the filter is arranged between an air outlet of the clothing accommodating device and an air inlet of the drying device to filter the airflow; and
the filter cleaning device is arranged on a non-filtering surface of the filter and is configured to clean the filter.

22. The clothing treatment apparatus according to claim 21, wherein the drying device comprises a moisture adsorption-desorption rotary disk; and the moisture adsorption-desorption rotary disk is rotatable;
a housing is configured to accommodate the moisture adsorption-desorption rotary disk; an internal space of the housing is divided into at least a moisture adsorption space and a moisture desorption space;
the moisture adsorption-desorption rotary disk, when rotating into the moisture adsorption space, serves as a moisture adsorption unit; and
the moisture adsorption-desorption rotary disk, when rotating into the moisture desorption space, serves as a moisture desorption unit.

23. The clothing treatment apparatus according to claim 22, further comprises an air outlet duct;
the air outlet duct is configured to guide an airflow from the clothing accommodating device to the drying device; and
the filter is arranged within the air outlet duct.

24. The clothing treatment apparatus according to claim 23, wherein the clothing accommodating device comprises an inner drum and an outer drum;
an air outlet of the clothing accommodating device is arranged on a rear wall of the outer drum; and
a length of the air outlet duct is greater than more than half of a diameter of the outer drum.
